(19) United States
(12) Patent Application Publication
(10) Pub. No.: US 2026/0344689 A1
(43) Pub. Date: Nov. 5, 2026

(54) IMPELLER FOR AUTOMATED MICROFOAMING

(71) Applicant: Subminimal Pte. Ltd., Singapore (SG)

(72) Inventor: Dominic Symons, Singapore (SG)

(21) Appl. No.: 19/384,195

(22) Filed: Nov. 10, 2025

Related U.S. Application Data
(63) Continuation-in-part of application No. 19/198,072, filed on May 4, 2025, now Pat. No. 12,492,706.

(51) Int. Cl. A23C 9/152; A47J 31/44; B01F 23/20; B01F 23/235; B01F 23/237; B01F 23/2375; B01F 27/113; B01F 27/118; B01F 27/808; B01F 27/91; B01F 35/22; B01F 35/221; B01F 35/32; B01F 101/07; B01F 101/14

(52) U.S. Cl. CPC A23C 9/1524; A47J 31/4496; B01F 23/2351; B01F 23/2375; B01F 23/237611; B01F 23/291; B01F 27/113; B01F 27/118; B01F 27/808; B01F 27/91; B01F 35/2206; B01F 35/221422; B01F 35/3204; A23C 2210/30; B01F 2101/07; B01F 2101/14

(57) ABSTRACT

An impeller and automated method are disclosed for creating consistent, fine-textured microfoam in beverages. The impeller has a screen adapted to draw liquid and bubbles downward, shearing them into smaller bubbles while preventing over-aeration. A processor controls impeller speed through stored rotational profiles and user-inputted, real-time speed adjustments, allowing automatic or user-directed incremental adjustment of vortex depth. Program modes for hot and cold operation execute defined stages including pre-heat, aerate, microfoam, and adjust-RPM phases. In hot mode, heating is coordinated with controlled speed reduction to maintain vortex balance, while in cold mode pre-stored speed algorithms achieve stable microfoam without heating. Memory retains optimized user-adjusted speeds for repeatability across cycles. The invention provides precise vortex control without external baffles or static flow guides, producing uniform microfoam texture independent of user skill.

### CROSS-REFERENCE TO RELATED APPLICATION

The present application claims the benefit of and is a continuation-in-part of U.S. Patent Application Serial No. 19/198,072 filed on May 4, 2025, which is incorporated by reference as if fully set forth herein.

### BACKGROUND

The present disclosure relates generally to a tool for preparing milk or milk-alternative for espresso or cocoa-based drinks such as cappuccinos, cafe lattes, and mochas.

### OBJECT AND SUMMARY

The object of the instant invention is to create a device and method that can produce microfoam repeatedly, consistently, and quickly without any learned skill or technique.

One exemplary embodiment of the disclosed subject matter is a novel impeller for automated microfoaming. The impeller preferably comprises a base, a means for coupling the base to a motor, a support wall extending upward from the base, a blade extending upward from the support wall, a shroud disposed about the blade, and a screen coupled to the shroud. The base has a top, an opposing bottom, and a central axis. The base is preferably substantially circular having an outer edge. A first end of the support wall extends upward from or about the outer edge. The support wall gradually curves inward toward the central axis of the base such that the second end of the support wall extends upward from or about the central axis. The support wall defines a channel, wherein the support wall and base define an outlet in communication with the channel.

A first end of the blade extends upward from or about a second end of the support wall. The blade extends along the support wall with a second end of the blade extending upward from the support wall from or about the first end of the support wall. The blade defines an inlet in fluid communication with the channel.

The shroud preferably comprises a ring, which may have knurls, and a wall extending downward from the ring. The wall of the shroud preferably engages the support wall. The coupling means may comprise magnets disposed about the bottom of the base for magnetically engaging the motor. In the alternative, the base may have receptacle, wherein the coupling means comprises magnets about the receptacle at the bottom of base for magnetically engaging the motor.

Another exemplary embodiment of the novel impeller for automated microfoaming includes a substantially circular base, a means for coupling the base to a motor, first and second curved support walls extending upward from the base, first and second curved blades extending upward from their respective support walls, first and second outlets, a shroud, a screen coupled to the shroud, and an inlet defined by the first and second curved blades.

The first curved support wall preferably extends upward from the outer edge of the base and curves radially inward toward the central axis of the base. A first end of the first curved blade extends upward from or about a second end of the first curved support wall. The second end of the first curved blade extends upward from or about the first end of the first curved support wall. A second curved support wall preferably extends upward from the outer edge of the base and curves radially inward toward the central axis. A first end of the second curved blade extends upward from or about a second end of the second curved support wall. The second end of the second curved blade extends upward from or about the first end of the second curved support wall.

The first outlet is preferably defined by the base, the second end of the first curved support wall, and the first end of the first blade. The second outlet is preferably defined by the base, the second end of the second curved support wall, and the first end of the second blade.

The shroud preferably has a ring and a wall extending downward from the ring. The wall of the shroud is preferably seated about the curved support walls.

Another exemplary embodiment of the disclosed subject matter is an automated frother for microfoaming a liquid. The microfoamer preferably includes a vessel for containing the liquid, an impeller disposed within the vessel, and a motor for spinning the impeller. The impeller preferably has a substantially circular base having an outer edge and a central axis. A first support wall extends upward from the base from or about the outer edge and curves inward toward the central axis. A first blade extends upward from the first support wall. A second support wall extends upward from the base from or about the outer edge and curving inward toward the central axis. A second blade extends upward from the second support wall.

A shroud, having a screen coupled thereto, is disposed about the first and second blades. The shroud may be fixed to the support walls. The shroud may have knurls for aiding the microfoaming process.

An inlet is defined by the first blade and the second blade, wherein the inlet receives the liquid to be microfoamed. A first outlet is defined by the first support wall, the second support wall, and the base, wherein the first outlet allows the liquid to be ejected radially outward away from the central axis while being microfoamed. A second outlet is defined by the first support wall, the second support wall, and the base, wherein the second outlet allows the liquid to be ejected radially outward away from the central axis while being microfoamed.

The motor is preferably variable-speed, wherein the vessel includes at least one button for varying power to the motor. The vessel may include a first container for holding the liquid to be microfoamed. The vessel may also include a second container for holding the motor. The automated frother may also have a means for detachably coupling the impeller to the motor.

Another exemplary embodiment of the disclosed subject matter is a method for automated microfoaming, comprising, under programmatic control, rotating an impeller within a liquid at a first rotational speed to aerate the liquid, subsequently rotating the impeller at a second, lower rotational speed to microfoam the liquid while maintaining vortex stability, and controlling the impeller speed through stored rotational profiles and user-inputted, real-time speed adjustments. The programmatic control may comprise executing stored instructions in a processor.

The impeller is preferably rotated at the first speed to introduce a controlled amount of air and at the second speed to refine bubbles and produce a smooth, homogeneous microfoam texture. The processor preferably executes a routine configured to adjust the impeller rotational speed in increments of between about one and about five percent of the current speed.

The method may further comprise heating the liquid to a predetermined temperature while dynamically maintaining a balanced rotational speed of the impeller to sustain vortex depth. The method may also include a cold program mode that operates without heating and utilizes a pre-stored rotational profile optimized for low-viscosity liquids to create stable microfoam. The method may comprise storing optimized, user-adjusted rotational speeds in non-volatile memory for automatic recall in subsequent program cycles. The method may also include the step of notifying a user when the liquid reaches a target temperature, viscosity condition, or predetermined microfoam completion criterion.

### BRIEF DESCRIPTION OF THE DRAWINGS

Some non-limiting exemplary embodiments of the disclosed subject matter are illustrated in the following drawings. Identical or duplicate or equivalent or similar structures, elements, or parts that appear in one or more drawings are generally labeled with the same reference numeral, optionally with an additional letter or letters to distinguish between similar objects or variants of objects, and may not be repeatedly labeled and/or described. Dimensions of components and features shown in the figures are chosen for convenience or clarity of presentation. For convenience or clarity, some elements or structures are not shown or shown only partially and/or with different perspective or from different point of views.

FIG. 1 is a top perspective view of an embodiment of the impeller disclosed herein, wherein the device is shown in its working environment before the impeller is coupled to a motor;

FIG. 2 shows the impeller seen in FIG. 1 after it is coupled to a motor;

FIG. 3 is an exploded, cross-sectional view of the impeller seen in FIG. 1;

FIG. 4A is a top perspective view of the impeller seen in FIG. 3;

FIG. 4B is an exploded view of the impeller seen in FIG. 4A;

FIG. 5 is a top view of the impeller seen in FIG. 1 without the shroud and screen;

FIG. 6A is an exploded, top perspective view of another embodiment of the impeller disclosed herein, wherein the shroud has knurls;

FIG. 6B is a top perspective view of the impeller seen in FIG. 6A;

FIG. 6C is a side view of the impeller seen in FIG. 6A;

FIG. 7 is a top perspective view of an embodiment of an automated frother with the impeller disclosed herein, wherein the automated frother has means for adjusting the speed of the motor;

FIG. 8 is a method flow diagram showing program selection (hot/cold), optional preheat, aeration, microfoam at perfect speed, incremental RPM adjustment, memory storage, temperature notifications, and cycle completion;

FIG. 9 illustrates an ultra-fast-for-aeration-condition in which deliberate aeration is produced at elevated RPM;

FIG. 10 illustrates a perfect-speed-condition in which a deep vortex forms and draws bubbles downward, while remaining spaced from the impeller so no new air is introduced;

FIG. 11 illustrates a slightly-too-fast-condition in which the vortex contacts the impeller, introducing new air and creating unintended bubbles; and

FIG. 12 illustrates a too-slow-condition in which surface foam and bubbles are not pulled down for refinement.

### DETAILED DESCRIPTION

The preparation of quality silky textured milk for a cappuccino that allows a barista to create elegant patterns on the drink known as “latte art” is commonly seen in coffee shops. Such shops use large commercial espresso machines containing multiple water boilers, one of which is dedicated to creating scalding and high pressured steam. This steam is pushed through a steam wand at high velocity to heat the milk and create foam. A knowledgeable barista may further break down the bubbles in the foam to create even smaller bubbles, which may be referred to as microfoam. Microfoamed milk mixes with the espresso when being poured and adds a nice perceived sweetness to the final drink.

While it is possible for the home barista to create foam using an espresso machine having a steam boiler and wand, it is quite a different feat to create silky microfoam textured milk suitable for creating latte art. The typical home machine is not as stout as the commercial machines found in coffee shops. Furthermore, many small home espresso machines do not include a second boiler or steam wand at all and only produce espresso, leaving the user unable to create any kind of microfoam milk.

In an attempt to supplement these deficiencies, frothing devices have been designed for home use. Such devices usually employ a small whisk to create ordinarily sized bubbles, resulting in the milk almost immediately separating and having a thick foam texture on top with milk at the bottom. When poured, the milk will come out first followed by a blob of foam at the end. This foam blob does not mix well with the espresso drink, creates a separation of flavors with frothy milk on top and espresso on the bottom, and does not permit the desirable latte art. In short, conventional handheld or automatic milk frothing devices do not create microfoam as there is no mechanism to break the bubbles down into microscopic homogenous milk texture.

One alternative to conventional handheld or automatic milk frothing devices is a French press. The method of use involves adding hot milk to the French press and vigorously pumping the plunger up and down to create foam, then slowing down the plunging motion to submerge the plunger until the foam is smooth. While this method may not achieve the same level of microfoam perfection as a skilled barista with a steam wand, the method is convenient and affordable to most ordinary home baristas.

Another alternative to conventional handheld or automatic milk frothers are the microfoaming devices disclosed in US 11,864,687, invented by the same inventor of the instant invention. These devices use an impeller with a unique configuration of a screen placed downstream of the flow to create the microfoam. Spinning at very high revolutions per minute, the impeller first agitates the milk to create normal foam, then adjusts in position or speed to pull down the newly created foam bubbles and tear them down into ultra-fine bubbles. In the second stage, as the milk, foam, and bubbles cycle around the vessel and through the impeller, the microfoam gradually gets finer and finer until a very homogenous texture, like wet paint, is created.

To create the perfect microfoam with a controllable amount of foam-to-milk ratio, the impeller must remain submerged during the entire second stage. An exposed impeller at any time during this stage may change or ruin the quality of the milk foam. To elaborate, if a deep vortex is formed by accident and the impeller becomes exposed, even for a fraction of a second, more air is added to the mix, and the foam-to-milk ratio changes, with more foam being accidentally created and the resulting texture being thicker than desired. If this accidental aeration happens near the end of the cycle, big bubbles will enter the impeller and will not be broken down, thus ruining the smooth effect of the microfoam.

Moreover, fluids build momentum over time when spun, even if they are being spun at a constant rate. This gradual gain in momentum leads to a gradually deeper vortex, which can expose the impeller, leading back to too much aeration by vortex, as discussed immediately above. Reducing the speed of the impeller removes the risk of accidental aeration; however, a greatly reduced speed also lacks the power to pull the air bubbles down to convert them to microfoam, leaving a layer of big bubbles floating on the surface. Reducing the speed of the impeller too much to avoid accidental aeration is thus not a workable solution.

Therefore, the challenge is finding a solution to allow the impeller to rotate as fast as possible while preventing a deep vortex from forming without using external fixed blades, baffles, or other flow control mechanisms.

Accordingly, a novel impeller and automated frothing device using such impeller, and method of using same, solving these and other problems is desired.

A general non-limiting overview of practicing the present disclosure is presented below. The overview outlines exemplary practice of embodiments of the present disclosure, providing a constructive basis for variant and/or alternative and/or divergent embodiments, some of which are subsequently described.

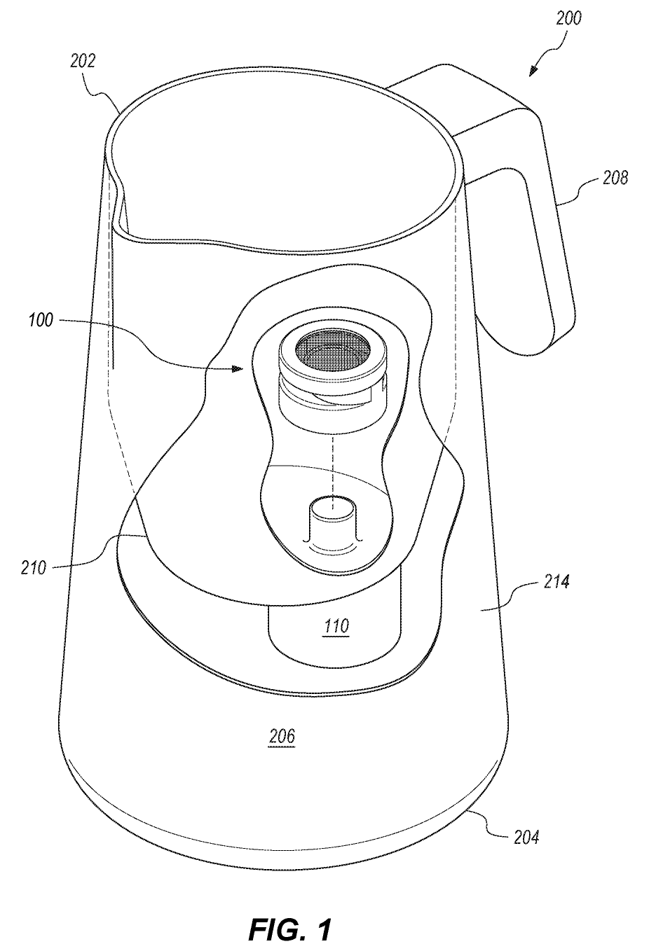

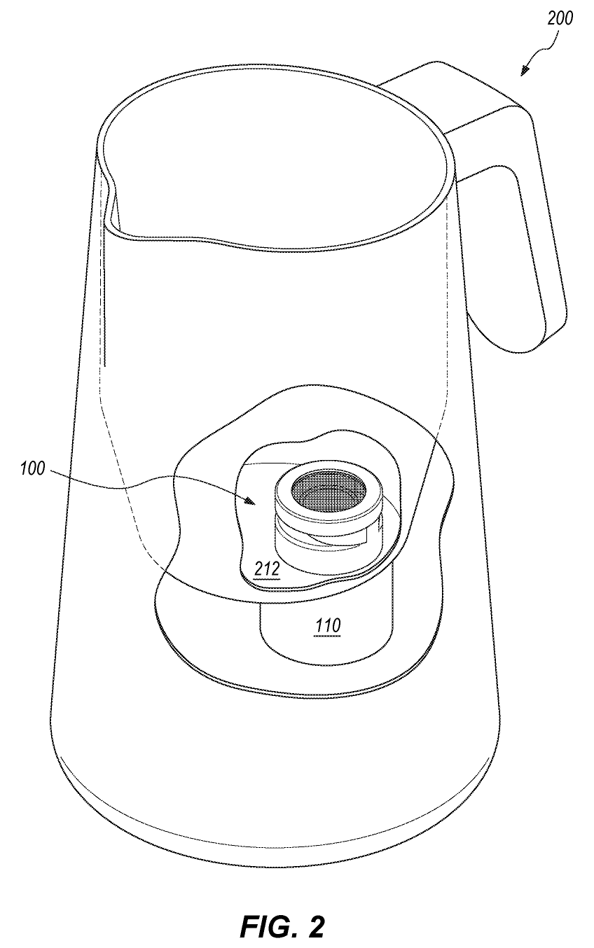

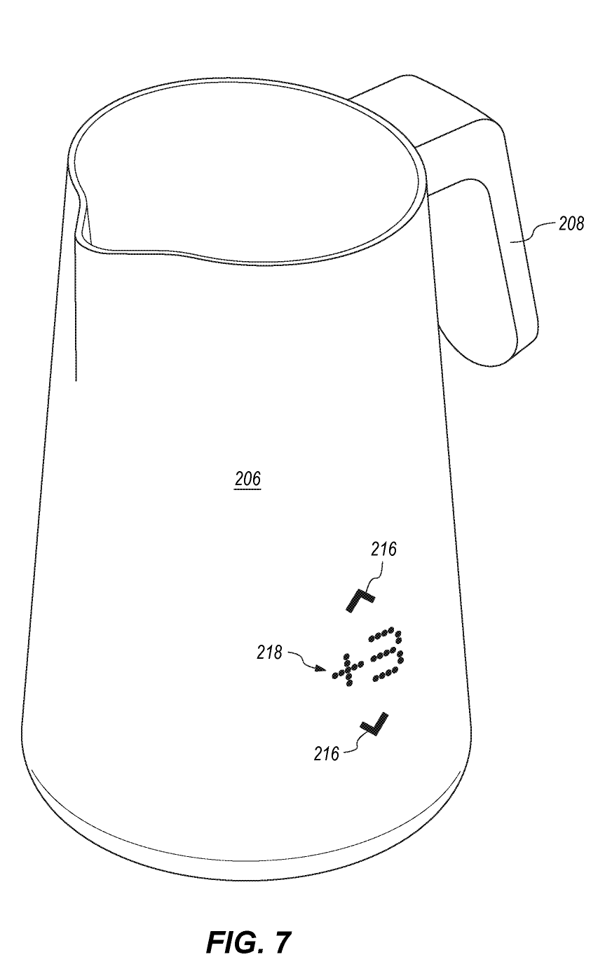

FIGS. 1-7 illustrate an impeller 100 for automated frothing of a liquid such as milk or a milk-alternative. The impeller 100 is preferably coupled to a motor 110, both of which may be handheld in a wand-like fashion. The impeller 100 may be contained in a vessel such as a pitcher or jug, and the motor 110 may be disposed outside of the pitcher or jug. FIG. 1 illustrates a vessel 202 having a bottom wall 204 and a side wall 206 extending upward from the bottom wall 204. The vessel 202 may have a handle 208 attached to and extending away from the side wall 206 of the vessel 202. The vessel 202 preferably has a first container 210 with its bottom wall 212, and a second container 214. FIG. 7 particularly illustrates a preferred automated frother 200 wherein the vessel 202 may have one or more buttons 216 for varying the power to the motor 110. The motor 110 is preferably a variable-speed motor, wherein a user of the automated frother 200 may push a button 216 to vary the speed of the motor 110, as seen by the indicia 218 on the side wall 206 of the vessel 202 in FIG. 7.

Turning to the details of impeller 100, it preferably comprises a base 102, a means for coupling 108 the base 102 to a motor 110, a support wall 112 extending upward from the base 102, a blade 126 extending upward from the support wall 112, a shroud 134 disposed about the blade 126, and a screen 142 coupled to the shroud 134.

Referring to FIG. 6C, the base 102 has a top 104, an opposing bottom 106, a central axis 124, and an outer edge 125.

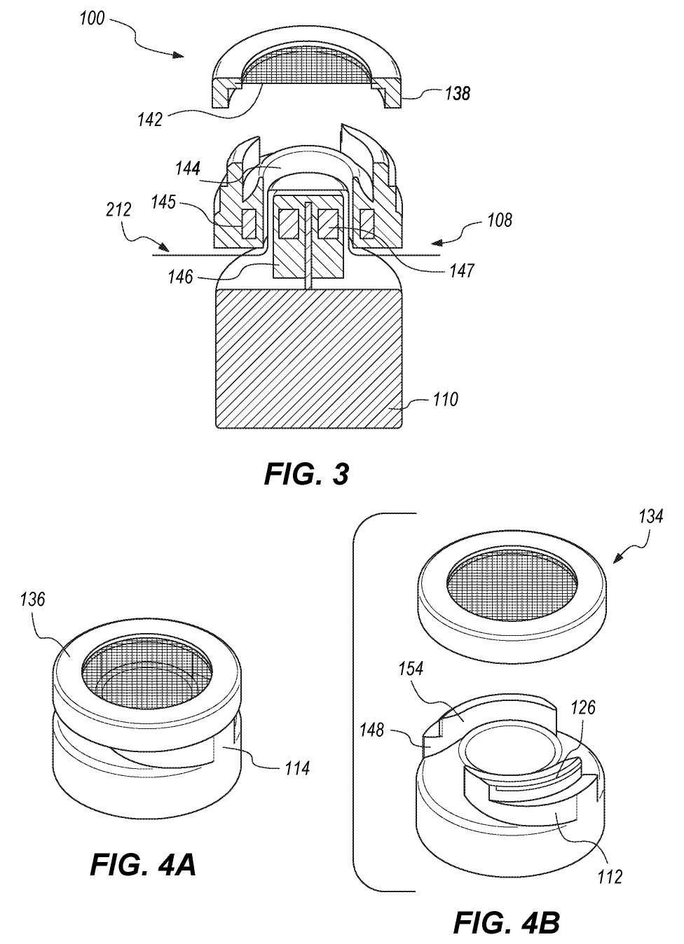

The means for coupling 108 may include the use of magnets, friction-fit, one or more pins or the like, direct mounting, and similar such arrangements. To elaborate with regard to direct mounting, the impeller 100 may be fixed to a motor shaft protruding through the bottom wall 204 of the vessel 202. With regard to a friction-fit arrangement, the base 102 may have a receptacle, such as receptacle 144, and the motor 110 may have a shaft or arm 146 extending therefrom wherein the receptacle 144 is adapted to receive the arm 146 and held in place by friction. With regard to the use of magnets, one arrangement includes magnets concentrically disposed about the impeller and another set of magnets radially along a motor shaft. As best seen in FIG. 3, the means for coupling 108 preferably includes the base 102 having a receptacle 144 adapted to receive an arm 146 of motor 110, a first set of magnets 145 disposed in the base 102 about the receptacle 144, and a second set of matching/opposing magnets 147 in the arm 146 of the motor. An air gap between the two magnets 145, 147 allows the means for coupling 108 to work through the vessel 202 and prevent leaks.

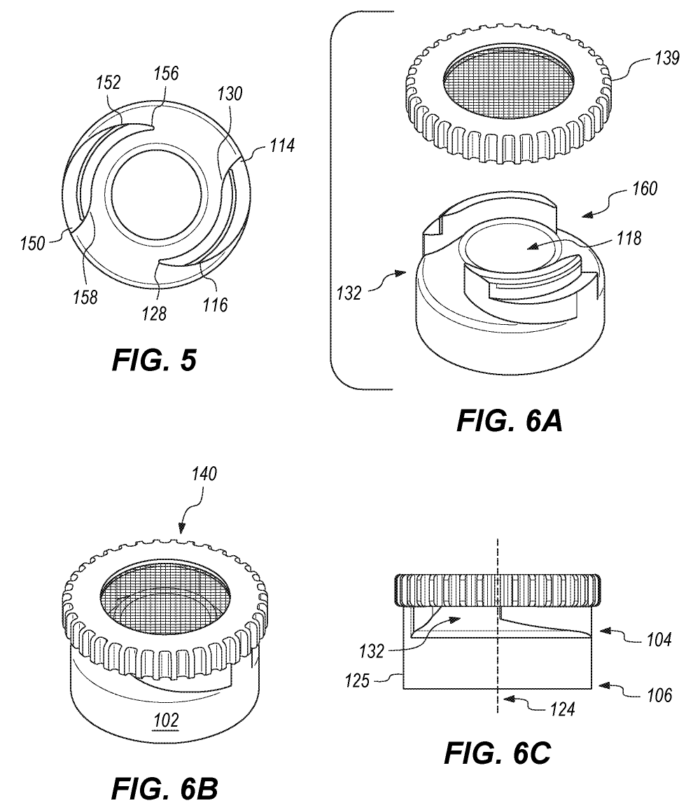

As best seen in FIGS. 5 and 6A-6B, the support wall 112 has a first end 114 and a second end 116. The support wall 112 defines a channel 118, wherein the support wall 112 and base 102 define an outlet 132 in communication with the channel. The blade 126, extending upward from the top of the support wall, defines an inlet 140 in fluid communication with the channel 118.

The impeller 100 preferably includes at least two support walls and blades. As the impeller 100 is preferably miniaturized, the use of fewer blades means each blade may be made larger and stronger. Turning to FIGS. 5-6C, the impeller 100 for microfoaming a liquid may include a substantially circular base 102 with its outer edge 125 and central axis 124. A first curved support wall 112, with its first end 114 and second end 116, has its first end 114 extend upward from the outer edge 125. The first curved support wall 112 curves radially inward toward the central axis 124 of base 102. The first curved blade 126, with its first end 128 and second end 130, has its first end 128 extend upward from or about the second end 116 of the first curved support wall 112. The second end 130 of the first curved blade 126 extends upward from or about the first end 114 of the first curved support wall 112. A second curved support wall 148 has a first end 150 and a second end 152, wherein the first end 150 extends upward from the outer edge 125 of the base 102. The second curved support wall 148 also curves radially inward toward the central axis 125 of the base 102. A second curved blade 154, having a first end 156 and a second end 158, extends upward from top of the second curved support wall 148. In particular, the first end 156 of the second curved blade 154 extends upward from or about the second end 152 of the second curved support wall 148. The second end 158 of the second curved blade 154 extends upward from or about the first end 150 of the second curved support wall 148.

With this arrangement, there is a first outlet 132 defined by the base 102, the second end 116 of the first curved support wall 112, and the first end 128 of the first blade 126. There is also a second outlet 160 defined by the base 102, the second end 152 of the second curved support wall 148, and the first end 156 of the second blade 154. The inlet 140 is defined by the first curved blade 126 and the second curved blade 154.

The first curved blade 126 and the second curved blade 154 are preferably designed to curve with a minimal angle to reduce fluid resistance as much as possible and thereby allow the impeller 100 to spin at an incredible speed. Blades 126 and 154 are preferably designed to guide the fluid flow radially toward the outer edge 125 of the base 102 of the impeller 100.

The shroud 134, which may be detachably coupled or fixed to the base 102, preferably includes a ring 136 having a wall 138 extending downward from the ring 136. The ring may have knurls 139, as seen in FIGS. 6A-6C, to aid the microfoaming process. As best seen in FIG. 3, the wall 138 of the shroud 134 is configured to be seated on the top of each of the first and second curved support walls 112, 148. In this manner, the shroud 134, with its screen 142, covers the inlet 140 while also being disposed above each curved blade 126, 154. The position of the screen 142, and the ring-like structure of the shroud 134, increases the efficiency of the impeller 100. Indeed, the disclosed impeller 100 allows for a very small diameter to be created. A small diameter can spin very fast in liquid using less power. Moreover, a small diameter impeller has less contact/friction with the liquid and produces less of a vortex, whereas a large diameter impeller tends to gradually increase the momentum of the spinning liquid and eventually create a deep vortex. Finally, a small diameter impeller allows for a faster-spinning screen 142 to break down big bubbles in the liquid faster and more efficiently than a slow-spinning screen 142.

In operation, a user of the impeller 100 may first desire to clean the impeller 100. To do so, the user may pull the shroud 134 away from the base 102 to unseat the shroud 134 from the support walls 112, 148, and thereby facilitating cleaning of the impeller 100. Once cleaned, the user places the impeller 100 onto the arm 146 of the motor 110. The magnets 145, 147 help hold the impeller 100 in place inside the vessel 202 when the motor 110 causes the impeller 100 to spin.

Next, the user pours a liquid to be microfoamed into the vessel 202. The liquid may be a milk or milk-based alternative, wherein the liquid may have varying degrees of viscosity and other properties. While the exact amount of liquid may vary depending on user preference, the user pours enough liquid to cover impeller 100. Once covered, the user turns on the unit 200 and then presses button 216 to change the amount of power to the motor 110.

In the first stage, the motor 110 rotates the impeller 100 extremely fast, creating a deep vortex and exposing impeller 100 to ambient air. This semi-exposed impeller 100 agitates the liquid, which is preferably milk, and makes bubbles.

In the second stage, the impeller 100 is slowed down to reduce the size of the vortex and allow the impeller 100 to rotate fully submerged. In this stage, no additional foam is created as the impeller 100 is not in contact with air. During this submerged stage, the impeller draws milk down through the inlet 140 of the impeller 100, forcing the milk and bubbles through the fast-rotating screen 142. As the milk passes through the screen 142, the bubbles are broken down into very fine bubbles and ejected out laterally through the outlets 132, 160. Recirculating and cycling this process eventually creates very fine homogenous microfoam texture.

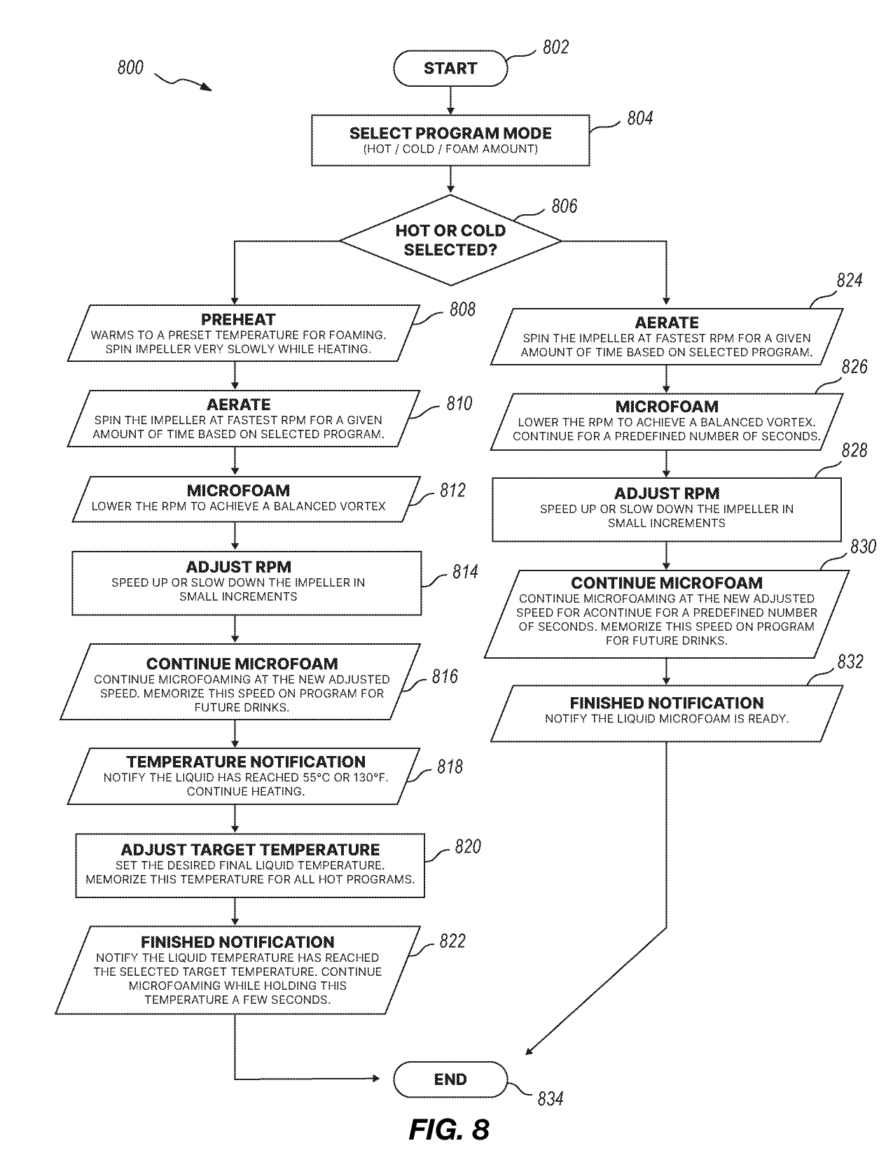

FIGS. 8-12 elaborate upon the inventive and automated method 800 for automated microfoaming using the exemplary device 200 disclosed herein. The device 200 incorporates user-adjustable speed parameters to achieve microfoam consistency across liquids of varying viscosity. The disclosed method 800 enables live, real-time adjustment of an impeller’s rotational speed, allowing a user to achieve a perfect vortex and optimal microfoam production regardless of the liquid’s viscosity, temperature, or composition.

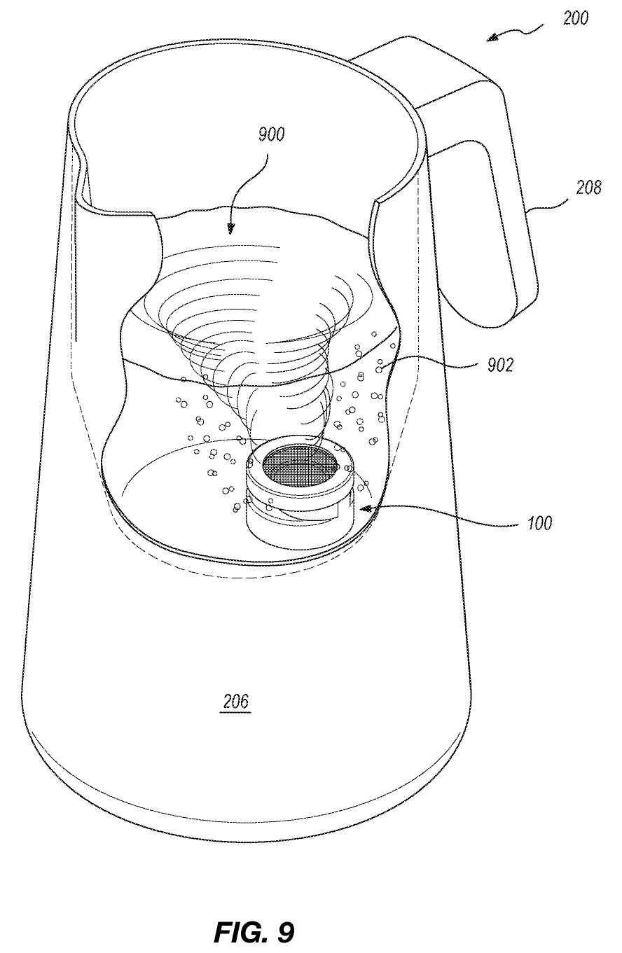

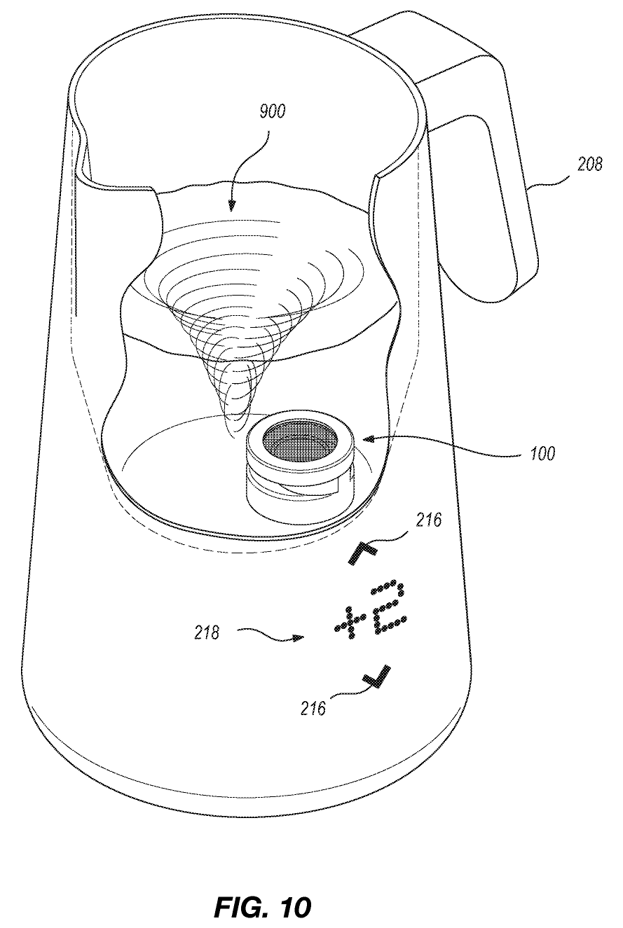

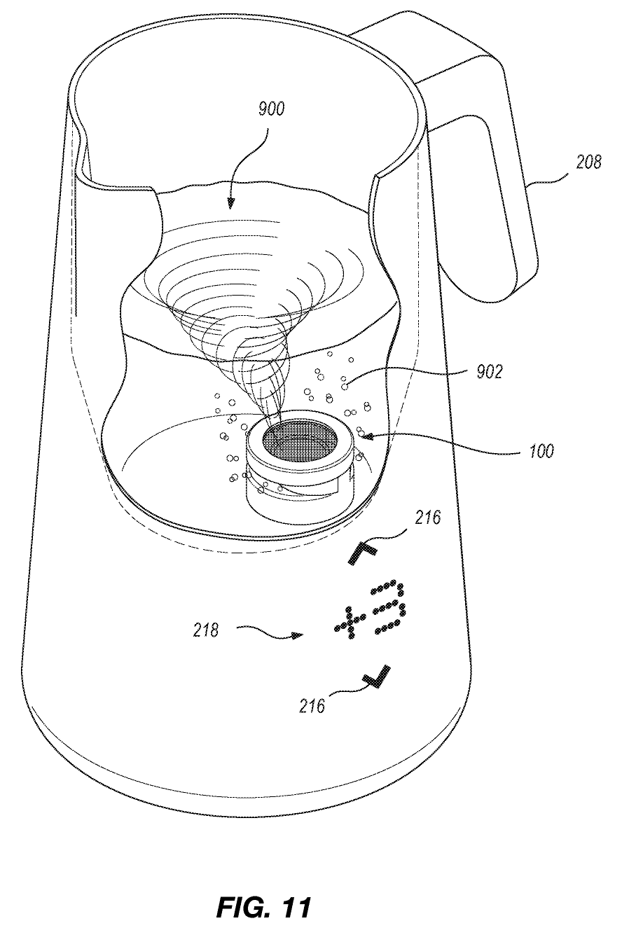

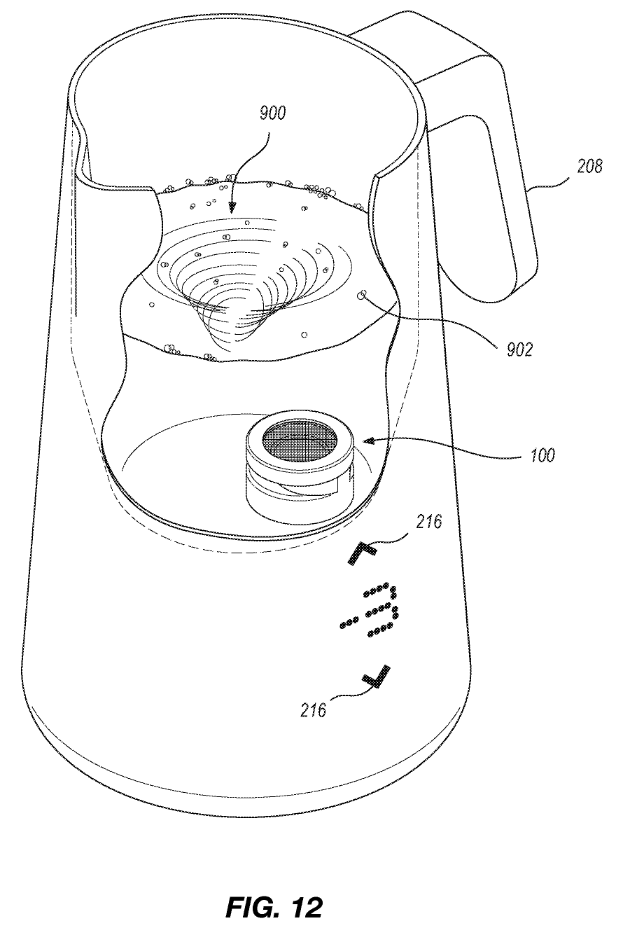

The inventive method 800 addresses the inherent variability of liquid viscosity, which is influenced by factors such as fluid type (for example, whole milk, skim milk, non-fat milk, or dairy alternatives), volume, added powders (for example, protein or chocolate), and temperature. As illustrated in FIGS. 9–12, the rotational speed of an impeller 100 positioned at the bottom of a jug dictates the depth of the vortex 900 created on the liquid’s surface. An impeller 100 speed that is too fast, shown in FIG. 11, causes the vortex 900 to contact the impeller, leading to the accidental introduction of new air and the formation of undesirable thick foam. Conversely, a speed that is too slow, shown in FIG. 12, produces a shallow vortex 900 that prevents foam and bubbles 902 from being drawn downward and churned by the impeller 100, thereby creating dry surface foam. The ideal rotational speed, shown in FIG. 10, forms a balanced vortex 900 that draws existing bubbles 902 downward for refinement without introducing additional air.

Precise management of this vortex 900 without external baffles or physical flow controllers is technically challenging to achieve at a static impeller speed because liquid viscosity changes continuously as heating, cooling, or ingredient dispersion occurs. Even minor variations in liquid properties can destabilize the vortex 900 and compromise microfoam texture.

The disclosed method 800 enables the user to incrementally adjust the impeller’s rotational speed in small, precise steps—preferably between one and five percent of the current speed—during the frothing process 800. This live adjustment allows the user to visually monitor the vortex 900 and make real-time corrections to maintain the ideal depth. A notable feature of the method 800 is the integration of this fine-tuning capability within a larger, program-based frothing process, as represented in the flow chart of FIG. 8. The flow chart illustrates a Microfoam stage 812 in which the impeller’s RPM is initially lowered to achieve a balanced vortex 900. If needed, the user may enter an Adjust RPM phase 814 to fine-tune the speed.

The automated frothing device 200 preferably includes a memory component that stores these optimal, user-adjusted speeds for specific programs. When the user fine-tunes the speed for a particular liquid type, the adjusted setting is saved, eliminating the need for future manual adjustment for that same program. This architecture provides a user-friendly and repeatable process for consistently producing high-quality microfoam. The method 800 thus overcomes the limitations of single-speed devices and the need for the user to estimate or pre-calculate impeller speed, resulting in a superior and more reliable frothing experience.

Turning in detail to FIG. 8, the method 800 begins at a Start stage 802 and proceeds to a Select Program Mode step 804. The user selects a Hot or Cold program mode at step 806 using a display that presents indicia 218. The indicia 218 may display stage status, temperature, and RPM increments, as well as confirm program selection. Memory retains program-specific optimized speeds to ensure repeatability. A processor is communicatively and functionally coupled to one or more sensors and to motor 110 via control circuitry, enabling RPM regulation. The processor receives sensor signals, executes stored instructions, and drives the motor 110 to implement incremental RPM adjustments in real time. The processor may be embodied as a microcontroller, ASIC, FPGA, or other dedicated circuitry. All program stages identified in FIG. 8 correspond to sequential control events executed by the processor, unless otherwise indicated.

If the Hot program mode is selected, the method enters a Pre-Heat stage 808, during which the impeller 100 rotates slowly while the liquid is warmed to a predetermined starting temperature. Once that temperature is reached, the method 800 advances to an Aerate stage 810, in which the impeller 100 is driven at a first, higher rotational speed to introduce a controlled amount of air into the liquid and create initial bubbles 902. During step 810, the method 800 also preferably comprises identifying a condition in which the vortex 900 contacts the impeller and reducing the rotational speed by an incremental amount to re-establish spacing. The method 800 may also further comprise identifying a condition in which surface foam is not entrained and increasing the rotational speed by an incremental amount to entrain bubbles 900 into the impeller 100. Detecting such conditions may comprise analyzing at least one of motor load, speed feedback, acoustic signature, or optical vortex depth sensing.

Upon completion of aeration, the processor automatically reduces impeller speed and advances to the Microfoam stage 812 to decrease vortex depth and maintain full submersion of the impeller 100. During this stage, bubbles 902 are continuously drawn through the impeller screen 142 and subdivided into finer bubbles 902, producing a smooth, homogeneous microfoam texture. The method 800 then progresses to the Adjust RPM phase 814, during which the user may increase or decrease impeller speed in small increments to refine vortex depth in real time. Adjustment may be performed through buttons 216, a rotary dial, a capacitive slider, or equivalent control inputs 216. Each incremental change is processed by the processor, which correspondingly modifies motor 110 output power.

Within the next step Continue Microfoam phase 816, the processor records the final optimized rotational speed associated with the selected program in memory. This stored value is automatically recalled during subsequent cycles of the same program, ensuring repetition of the optimized microfoaming conditions without further user input. During step 816, the device 200 continues microfoaming at the new adjusted speed.

As the liquid temperature continues to rise in the Hot program, a Temperature Notification step 818 may alert the user that the liquid has reached approximately 55 °C (130 °F). The user may then adjust the target temperature at step 820, wherein the processor saves this temperature for all hot programs. In the next step, the Finished Notification phase 822, the processor indicates when the liquid temperature has reached the selected target temperature and/or when time or texture is reached.

The process then continues microfoaming while holding this temperature a few seconds. The method 800 for the Hot program then ends at stage 834. The cycle then returns to the Start stage 802 or standby mode, ready for the next use.

If the Cold program mode is selected at step 806, the method 800 bypasses the Pre-Heat stage 808 and begins directly with Aerate stage 824. Because temperature does not rise appreciably during cold operation, the device 200 uses pre-stored RPM profiles optimized for cold liquids. The impeller 100 accelerates to a predetermined high speed sufficient to initiate controlled aeration without causing splashing or air over-entrainment. Following aeration, the processor automatically transitions to the Microfoam stage 826, reducing impeller speed to establish a stable, balanced vortex 900 for a predefined number of seconds. Cold microfoaming benefits from prolonged circulation and bubble shearing rather than heat integration; therefore, the controller may maintain the Microfoam stage 826 for a longer duration (compared to the Hot program) while monitoring motor load or acoustic feedback to verify vortex 900 balance.

The method 800 then progresses to the Adjust RPM phase 828, during which the user may increase or decrease impeller speed in small increments to refine vortex depth in real time. Adjustment may be performed through buttons 216, a rotary dial, a capacitive slider, or equivalent control inputs 216. Each incremental change is processed by the processor, which correspondingly modifies motor 110 output power.

Within the next step Continue Microfoam phase 830, the processor records the final optimized rotational speed associated with the selected program in memory. This stored value is automatically recalled during subsequent cycles of the same program, ensuring repetition of the optimized microfoaming conditions without further user input. During step 830, the device 200 continues microfoaming at the new adjusted speed for a predefined number of seconds. A Finished Notification stage 832 is issued when the liquid microfoam texture is reached. The resulting cold microfoam exhibits uniform texture and stability suitable for iced or chilled beverages. The method 800 for the Cold program then ends at stage 834. The cycle then returns to the Start stage 802 or standby mode, ready for the next use.

The disclosed method 800 thereby maintains precise vortex control without external baffles or static flow guides. The incremental-adjustment aspect compensates for viscosity changes that occur as temperature rises in the Hot mode or as density changes in the Cold mode. The result is consistent, fine-textured microfoam across a wide range of liquids and serving temperatures.

It should now be apparent that even an inexperienced barista may employ the disclosed impeller and automated frother, and method of use thereof, to create the perfect microfoam. Moreover, one of ordinary skill in the art should also readily understand the novel impeller solves the problems of (1) too much aeration by vortex and, conversely, (2) insufficient speed that introduces big bubbles that ruin the smooth effect of the microfoam. In particular, as the screen 142 covers the inlet 140 of the impeller 100, the impeller advantageously rotates as fast as possible while preventing a deep vortex from forming without using external fixed blades, baffles, or other flow control mechanisms. The particular screen-inlet arrangement allows some milk to flow through the channel 118 while the remaining milk flows over the top of the impeller 100 and recirculates. It is this portion of the milk flowing over the impeller 100 that helps close the vortex and prevent aeration, even when rotating at high speeds. With the disclosed arrangement, a user now advantageously has a high-speed impeller that draws milk and bubbles down, cuts the bubbles through the fine mesh of the screen, and recirculates the foam while efficiently controlling the vortex depth to avoid accidental aeration. The invention provides numerous advantages including consistent microfoam quality across liquids, elimination of guesswork, automatic repeatability, and reduced cleaning complexity.

While certain embodiments have been described, the embodiments have been presented by way of example only and are not intended to limit the scope of the inventions. Indeed, the novel impeller and automated frother and method of use thereof described herein may be embodied in a variety of other forms. For example, dimensions, materials, and geometry may vary to suit different vessel sizes and use cases, provided the functional relationships described herein are maintained. Furthermore, various omissions, substitutions, and changes in the form of the disclosed elements may be made without departing from the spirit of the inventions. The accompanying claims and their equivalents are intended to cover such forms or modifications as would fall within the scope and spirit of the inventions.

1. A method for automated microfoaming, comprising, under programmatic control:
rotating an impeller within a liquid at a first rotational speed to aerate the liquid;
subsequently rotating the impeller at a second, lower rotational speed to microfoam the liquid; and
controlling vortex stability through stored rotational profiles and user-inputted, real-time speed adjustments.

2. The method of claim 1, wherein the programmatic control comprises executing stored instructions in a processor and receiving feedback from a temperature sensor and the user-inputted, real-time speed adjustments.

3. The method of claim 1, wherein the impeller is rotated at the first speed to introduce a controlled amount of air and at the second speed to refine bubbles and produce a smooth, homogeneous microfoam texture while maintaining vortex stability.

4. The method of claim 1, wherein the processor executes stored user-inputted, real-time speed adjustments in increments of between about one and about five percent of the current speed.

5. The method of claim 1, further comprising heating the liquid to a predetermined temperature while dynamically maintaining a balanced rotational speed of the impeller to sustain vortex depth.

6. The method of claim 1, wherein a cold program mode operates without heating and utilizes a pre-stored rotational profile optimized for low-viscosity liquids to create stable microfoam.

7. The method of claim 1, further comprising storing optimized, user-adjusted rotational speeds in non-volatile memory for automatic recall in subsequent program cycles.

8. The method of claim 1, further comprising notifying a user when the liquid reaches a target temperature, viscosity condition, or predetermined microfoam completion criterion.

9. A method for automated microfoaming comprising:
(a) providing a vessel containing a liquid;
(b) providing an impeller within the vessel to aerate the liquid, wherein the impeller comprises:
a base having a top, an opposing bottom, and a central axis;
a means for coupling the bottom of the base to a motor;
a support wall extending upward from the top of the base, the support wall defining a channel, wherein the support wall and base define an outlet in communication with the channel;
a blade extending upward from the support wall, the blade defining an inlet in fluid communication with the channel;
a shroud disposed about the blade; and
a screen coupled to the shroud;
(c) rotating the impeller within the vessel at a first rotational speed;
(d) lowering the rotational speed of the impeller to a balanced rotational speed at which a vortex forms and remains spaced from the impeller while existing bubbles are drawn downward and refined through the screen; and
(e) during microfoaming, adjusting the rotational speed of the impeller to maintain the condition of step (d).

10. The method of claim 9, further comprising storing a final adjusted rotational speed in memory for automatic use in a subsequent cycle of a selected program.

11. A method for automated microfoaming comprising:
(a) providing a vessel containing a liquid;
(b) providing an impeller disposed within the vessel;
(c) providing a motor for spinning the impeller; wherein the impeller comprises:
a substantially circular base having an outer edge and a central axis;
a first support wall extending upward from the base from or about the outer edge and curving inward toward the central axis;
a first blade extending upward from the first support wall;
a second support wall extending upward from the base from or about the outer edge and curving inward toward the central axis; a second blade extending upward from the second support wall;
a shroud disposed about the first blade and the second blade;
a screen coupled to the shroud;
an inlet defined by the first blade and the second blade, the inlet for receiving liquid to be microfoamed;
a first outlet defined by the first support wall, the second support wall, and the base, the first outlet for allowing liquid to be ejected radially outward away from the central axis while being microfoamed; and
a second outlet defined by the first support wall, the second support wall, and the base, the second outlet for allowing liquid to be ejected radially outward away from the central axis while being microfoamed;
(d) rotating the impeller within the vessel at a first rotational speed;
(e) lowering the rotational speed of the impeller to a balanced rotational speed at which a vortex forms and remains spaced from the impeller while existing bubbles are drawn downward and refined through the screen; and
(f) during microfoaming, adjusting the rotational speed of the impeller to maintain the condition of step (e).

12. The method of claim 11, further comprising the step of storing a final adjusted rotational speed in memory for automatic use in a subsequent cycle of a selected program.

13. The method of claim 12, wherein the stored rotational speed is associated with a program corresponding to a particular liquid type.
